(19) United States
(12) Patent Application Publication
(10) Pub. No.: US 2003/0133297 A1
(43) Pub. Date: Jul. 17, 2003

(54) Vehicle light beam adjusting device

(76) Inventor: Jen Hsieh Shin, Chang Hua (TW)

Correspondence Address: Jen Hsieh Shin, 7F, No. 46,, Pin Ho 10 Street, Chang Hua, 500, TW

(21) Appl. No.: 10/045,078

(22) Filed: Jan. 15, 2002

(51) Int. Cl. F21V 1/00

(52) U.S. Cl. 362/286

(57) ABSTRACT

An adjustable vehicle light device for a vehicle includes a housing secured to the vehicle, a reflector disposed in front of the housing, a light bulb slidably engaged through the bore of the reflector. A solenoid device is received in the housing and coupled to the light bulb for moving the light bulb relative to the reflector and the housing and for adjusting the light beam of the vehicle. The solenoid device includes a core slidably received in a coil and coupled to a socket of the light bulb for moving the socket and the light relative to the housing and the reflector.

The present invention is related to U.S. patent application Ser. No. 09/800,644, filed on Mar. 3, 2001.

### BACKGROUND OF THE INVENTION

1. Field of the Invention

The present invention relates to a vehicle light, and more particularly to a vehicle light having a light beam adjusting device for adjusting the light beam of the vehicle.

2. Description of the Prior Art

Typical vehicle light devices comprise a halogen light bulb plugged to a socket which is secured to the vehicle, and which includes three prongs 16 coupled to the electric power of the vehicle. The light bulb includes two lamp wicks having different lengths and to be energized separately or alternatively for adjusting the light beams of the vehicle. However, the light is not good enough for lighting purposes.

The other typical vehicle head lights are made of or include xenon light bulbs that are secured to the vehicle, and each comprises a single lamp wick for generating lights. However, the vehicle light may not be adjusted to different light beam with such xenon light bulbs.

The present invention has arisen to mitigate and/or obviate the afore-described disadvantages of the conventional vehicle light devices.

### SUMMARY OF THE INVENTION

The primary objective of the present invention is to provide a vehicle light including a light beam adjusting device for adjusting the light beam of the vehicle.

In accordance with one aspect of the invention, there is provided an adjustable vehicle light device for a vehicle, the vehicle light device comprising a housing for securing to the vehicle, a reflector disposed in front of the housing and including a bore formed therein, a socket movable relative to the housing, a light bulb slidably engaged through the bore of the reflector, and plugged to the socket, and a solenoid device received in the housing, and includes a coil, and a core slidably received in the coil and coupled to the socket for moving the socket and the light bulb relative to the reflector and the housing.

The socket includes an aperture formed therein, the core includes a hook engaged into the aperture for coupling the socket to the core. The socket includes a space communicating with the aperture thereof for receiving the core and the hook and for allowing the hook to be engaged into the aperture of the socket.

The housing includes an orifice formed therein, a gasket engaged in the orifice of the housing, the solenoid device includes an electric wire engaged outward of the housing through the gasket.

The housing includes a groove formed therein, the socket includes at least one electric wire engaged outward of the housing through the groove of the housing for coupling to an electric power source. The housing includes a pin extended therefrom, the electric wire includes a first coupler engaged onto the pin, and at least one second electric wire includes a second coupler engaged onto the pin and electrically coupled to the first coupler.

The housing includes a depression formed therein, the pin is extended inward of the depression of the housing, the depression of the housing is provided for receiving the first coupler and the second coupler.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a partial exploded view illustrating a vehicle light in accordance with the present invention;

FIG. 2 is a perspective view of the vehicle light;

FIG. 3 is a partial cross sectional view taken along lines 3-3 of FIG. 2; and

FIG. 4 is a partial cross sectional view similar to FIG. 3, illustrating the operation of the vehicle light.

### DETAILED DESCRIPTION OF THE PREFERRED EMBODIMENT

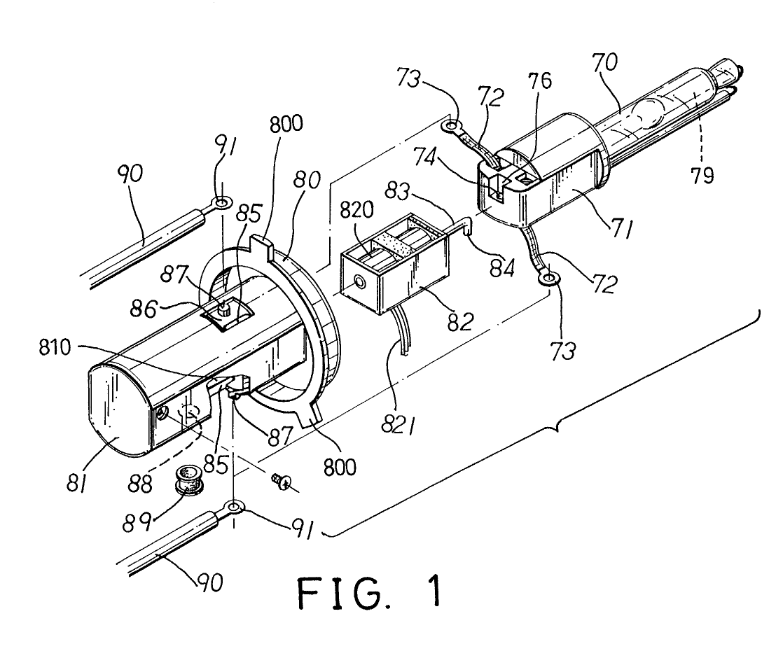

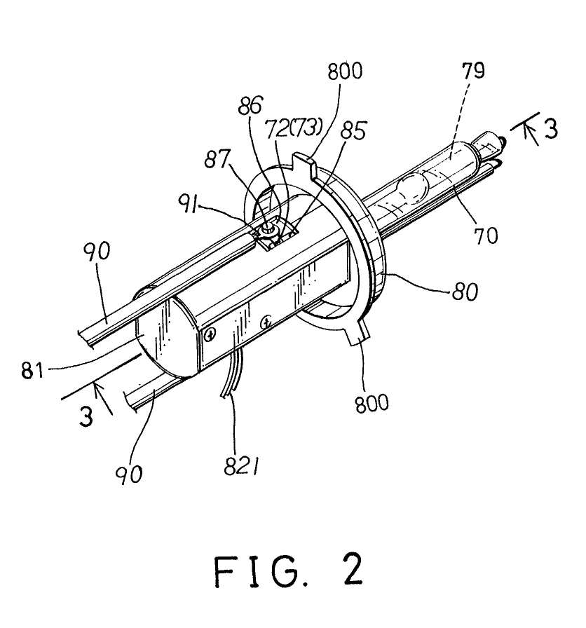

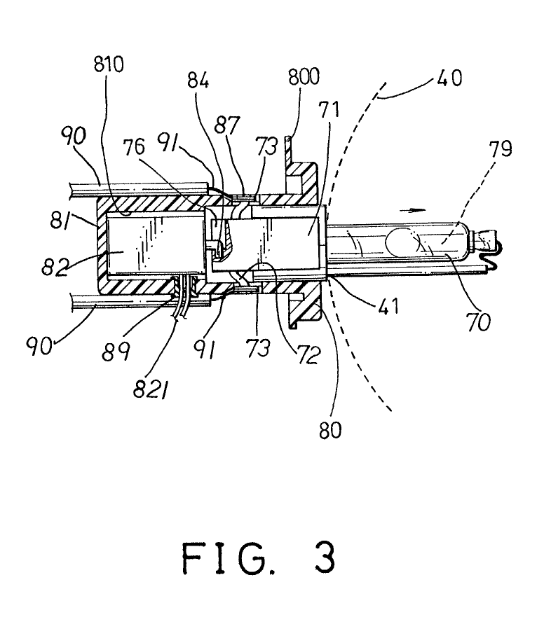

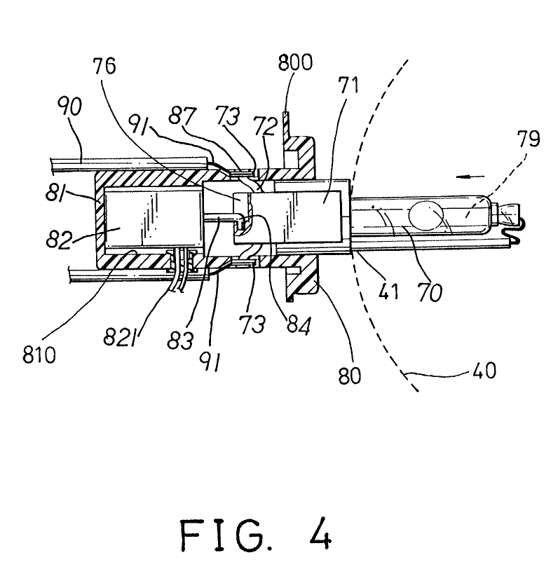

Referring to the drawings, and initially to FIGS. 1-3, a vehicle light in accordance with the present invention comprises a housing 81 including one or more catches 800 laterally or radially extended outward from the front portion 80 thereof for securing to the vehicle, and including a chamber 810 formed therein for receiving a solenoid device 82 therein, and including an orifice 88 formed therein and communicating with the chamber 810 thereof. The solenoid device 82 may be secured and retained in the chamber 810 of the housing 81, with such as fasteners, adhesive materials, or by latches or the other lock devices (not shown). Particularly, as shown in FIGS. 3 and 4, the solenoid device 82 is secured in the rear portion or in the inner portion of the chamber 810 of the housing 81. The vehicle includes a reflector 40 secured to the vehicle and located in front of the housing 81 and having a bore 41 formed therein.

The solenoid device 82 includes a coil 820, a core 83, such as an iron core 83 slidably received in the coil 820 and having a hook 84 formed or provided on one end thereof, and includes a coupling electric wire 821 for coupling to the electric power of the vehicle. A xenon light bulb 70 is plugged to a socket 71 and slidably engaged through the bore 41 of the reflector 40, and includes one or more lamp wicks 79 provided therein. The socket 71 is slidably received in the front portion of the chamber 810 of the housing 81, located in front of the solenoid device 82, and includes a space 76 and an aperture 74 formed in the rear portion thereof for receiving the iron core 83 and/or the hook 84 and for allowing the hook 84 to be engaged into the aperture 74 of the socket 71, and for allowing the socket 71 and thus light bulb 70 to be moved relative to the housing 81 and the reflector 40 by the solenoid device 82.

A gasket 89 is engaged into the orifice 88 of the housing 81 for safely receiving the coupling electric wire 821. The housing 81 includes a pair of opposite depressions 86 formed therein, and a pair of grooves 85 formed therein and communicating with the depressions 86 thereof, and a pair of pins 87 extended therefrom, such as extended inward of the depressions 86 thereof. The socket 71 includes one or more, such as two electric wires 72 engaged through the grooves 85 of the housing 81, and two couplers 73 secured to the electric wires 72 and engaged onto the pins 87 respectively. One or more, such as two further electric wires 90 are provided and each includes a coupler 91 engaged onto the respective pin 87 and electrically coupled to the couplers 73 for coupling the light bulb 70 to the electric power of the vehicle. The couplers 73, 91 may further be solidly secured to the respective pins 87 by additional fasteners (not shown), and may be received in the depressions 86 of the housing 81 without affecting the coupling of the housing 81 to the vehicle.

In operation, as shown in FIGS. 3 and 4, the light bulb 70 and the socket 71 may be moved relative to the housing 81 and the reflector 40 by the solenoid device 82 in order to adjust the light beam of the vehicle, when the iron core 83 is moved relative to the solenoid device 82 by the energizing of the coil 820. The xenon light bulb 70 may generate a light having a light intensity three or more times greater than that of the typical halogen light bulbs. The electric wires 72 include a flexibility or include a length large enough without interfering the movement of the socket 71 relative to the housing 81.

Accordingly, the vehicle light in accordance with the present invention includes a light beam adjusting device for easily adjusting the light beam of the vehicle.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An adjustable vehicle light device for a vehicle, said vehicle light device comprising:
a housing for securing to the vehicle,
a reflector disposed in front of said housing and including a bore formed therein,
a socket movable relative to said housing,
a light bulb slidably engaged through said bore of said reflector, and plugged to said socket, and
a solenoid device received in said housing, and includes a coil, and a core slidably received in said coil and coupled to said socket for moving said socket and said light bulb relative to said reflector and said housing.

2. The vehicle light device according to claim 1, wherein said socket includes an aperture formed therein, said core includes a hook engaged into said aperture for coupling said socket to said core.

3. The vehicle light device according to claim 2, wherein said socket includes a space formed therein and communicating with said aperture thereof for receiving said core and said hook and for allowing said hook to be engaged into said aperture of said socket.

4. The vehicle light device according to claim 1, wherein said housing includes an orifice formed therein, a gasket engaged in said orifice of said housing, said solenoid device includes an electric wire engaged outward of said housing through said gasket.

5. The vehicle light device according to claim 1, wherein said housing includes a groove formed therein, said socket includes at least one electric wire engaged outward of said housing through said groove of said housing for coupling to an electric power source.

6. The vehicle light device according to claim 5, wherein said housing includes a pin extended therefrom, said at least one electric wire includes a first coupler engaged onto said pin, and at least one second electric wire includes a second coupler engaged onto said pin and electrically coupled to said first coupler.

7. The vehicle light device according to claim 6, wherein said housing includes a depression formed therein, said pin is extended inward of said depression of said housing, said depression of said housing is provided for receiving said first coupler and said second coupler.
